(19) United States
(12) Patent Application Publication
(10) Pub. No.: US 2012/0005101 A1
(43) Pub. Date: Jan. 5, 2012

(54) System and Method for Offering Bulk Products for Sale to Multiple Businesses by Provision Point Mechanism

(76) Inventor: Cary Chessick, Arlington Heights, IL (US)

(21) Appl. No.: 12/829,525

(22) Filed: Jul. 2, 2010

(51) Int. Cl. G06Q 30/00

(52) U.S. Cl. 705/80

(57) ABSTRACT

A method for business-to-business (B2B) provisioning implemented on a computer system. Information is stored for at least one purchase offer concerning an associated product or service. The stored information identifies the associated product or service, a number of current acceptances of the offer made by one or more businesses, and a number of acceptances required for activating an associate purchase order. Upon receipt of a next acceptance of the offer, the computer system operates to update the number of current acceptances, and to determine whether the updated number of current acceptances is greater than or equal to the number of acceptances required for activating the associate purchase order. If a time period for accepting the offer has expired and the updated number of current acceptances is greater than or equal to the number of required acceptances, the computer places an associated order with an associated supplier.

### FIELD OF THE INVENTION

The present application is directed to a system and method for providing bulk products for sale to businesses, and more particularly, for providing bulk products to multiple businesses in time and quantity limited deals according to a provision point mechanism.

### BACKGROUND OF THE INVENTION

Business to business (“B2B”) transactions which occur via computers and various communications systems have become commonplace. For example, electronic commerce (“e-commerce”) systems, services and software are known whereby companies may enter into purchase and sale transactions on an automatic or semiautomatic basis. Through the use of these e-commerce systems, purchasing entities may, for example, be set up to automatically receive re-orders of consumable supplies on a rolling basis from a predetermined supplier. This approach may be particularly suitable, for example, for manufacturers and other service providers (e.g., restaurants) that consume these supplies at a relatively level rate over some period of time.

In some cases, the price and quantity may be pre-negotiated or at least known ahead of time by the purchaser. In other cases, the purchaser may agree that it will accept a certain quantity on a rolling basis at the then current market price, whatever it may be. Communications in these systems between buyers and sellers may occur through various communication channels such as the Internet, private local or wide area network or dialup access.

While these systems are extremely successful, they do suffer drawbacks. By way of example, existing e-commerce systems and services generally require the purchaser to pre-select its suppliers with respect to specific goods and/or services. In many cases where rolling orders are used, the purchasing entity is required to accept goods/services at a future price which is likely unknown at the time of the initial order or when the relationship is set up. This can be disadvantageous to the purchaser not only in terms of pricing, but also in terms of product/service quality and fitness for purpose. In addition, in the case of small businesses, the quantities ordered in the rolling orders are often too small to be eligible for supplier discounts.

U.S. Pat. No. 7,124,107 to Pishevar et al. (“the '107 patent”), which is hereby incorporated by reference in its entirety herein, discloses a collective procurement management system which enables multiple small business purchasers to place a group or collective order in order to obtain the benefits of supplier discounts associated with purchasing items in sizable or large quantities (“bulk purchases”). The system disclosed by the '107 patent negotiates the group purchase by storing information for each purchaser specifying a maximum price the purchaser is willing to pay for a series of items, and information provided by each supplier how price varies as a function of sales volume. As a standing order-based system, the purchaser generally does not participate in considering whether or not to proceed with each order. While the system optionally allows the purchaser to pre-approve orders prior to fulfillment, this option suffers the disadvantage of adding additional complexity and potential delay to the order process.

In a different arena, a number of on-line providers of consumer products promote a simplified system for obtaining supplier discounts by featuring a “deal-of-the-day” (for example, Groupon.com). In this system, a consumer is offered the opportunity to enter into a binding agreement (“assurance contract”) with the provider in which the consumer irrevocably agrees to purchase an item at a fixed discounted price in the event that the provider is able to furnish the item at the agreed price. The provider's ability to furnish the item at the discounted price typically requires the provider to obtain a sufficient number of purchase agreements from consumers during a predetermined time period that reach a predetermined sales volume. In the event that the number of purchase agreements does not reach the predetermined sales volume, the deal is off and no sales are made. This type of arrangement is also commonly referred to as a “provision point mechanism,” as the triggering and execution of the assurance contract is dependent upon the provider reaching the predetermined sales volume (i.e., the “provision point”). To date, application of this approach has been limited to consumer markets and to sales items including, for example, discount coupons for application to promote the sale of consumer products and services. Quite often, the coupons provide significant discounts directed to attract new customers and/or introduce new products and services by providing an initial, heavily discounted product or service offering.

### SUMMARY OF THE INVENTION

The present invention is directed to a system and method for business-to-business (B2B) provisioning implemented on a computer system. In accordance with a preferred embodiment of the present invention, information is stored for at least one purchase offer to one or more businesses concerning an associated product or service. The stored information identifies the associated product or service, a number of current acceptances of the offer made by the one or more businesses, and a number of acceptances required for activating an associated purchase order. Upon receipt of a next acceptance of the offer, the computer system updates the stored information to include a revised number of current acceptances, and determines whether the revised number of current acceptances is greater than or equal to the number of acceptances required for activating the associated purchase order. If a time period for accepting the offer has expired and the updated number of current acceptances is greater than or equal to the number of require acceptances, the computer system places an associated order with an associated supplier. The supplier may be a group buying organization, a manufacturer and/or a distributor.

In a preferred embodiment of the invention, the one or more businesses are restaurants. The method may be used to provide only a single purchase offer each day that expires at the conclusion of the day. Alternatively, the method may be used to provide multiple offers each day, having varying expiration periods (for example, after one week or one month). The method may employ the computer system to analyze one or more of historical order data and other purchase data provided by one or more associated suppliers to select purchase offers having a high likelihood of demand and to set thresholds for the required number of acceptances. In addition, the method may be used to provide a preview of planned offers for a defined time period (for example, to provide a “90-day pipeline”).

### BRIEF DESCRIPTION OF THE DRAWINGS

The invention will become more readily apparent from the Detailed Description of the Invention, which proceeds with reference to the drawings, in which:

FIG. 1 presents a schematic diagram illustrating an e-commerce system according to the present invention;

FIG. 2 presents a flow diagram illustrating a collective purchase process according to a preferred embodiment of the present invention;

FIG. 3 presents a flow diagram illustrating a process for selecting offers according to the process of FIG. 2;

FIG. 4 illustrates an exemplary computer screen for presenting an offer to a buyer in accordance with the collective purchase process of FIG. 2; and

FIG. 5 presents a schematic diagram illustrating a computer system suitable for implementing a portion of the e-commerce system of FIG. 1.

### DETAILED DESCRIPTION OF THE INVENTION

Reference will now be made in detail to exemplary embodiments of the invention, including the best modes contemplated by the inventors for carrying out the invention. Examples of these exemplary embodiments are illustrated in the accompanying drawings. While the invention is described in conjunction with these embodiments, it will be understood that it is not intended to limit the invention to the described embodiments. Rather, the invention is also intended to cover alternatives, modifications, and equivalents as may be included within the spirit and scope of the invention as defined by the appended claims. In the following description, specific details are set forth in order to provide a thorough understanding of the present invention. The present invention may be practiced without some or all of these specific details. In other instances, well-known aspects have not been described in detail in order not to unnecessarily obscure the present invention.

In this specification and the appended claims, the singular forms “a,” “an,” and “the” include plural references unless the context clearly dictates otherwise. Unless defined otherwise, all technical and scientific terms used herein have the same meaning as commonly understood to one of ordinary skill in the art to which this invention belongs.

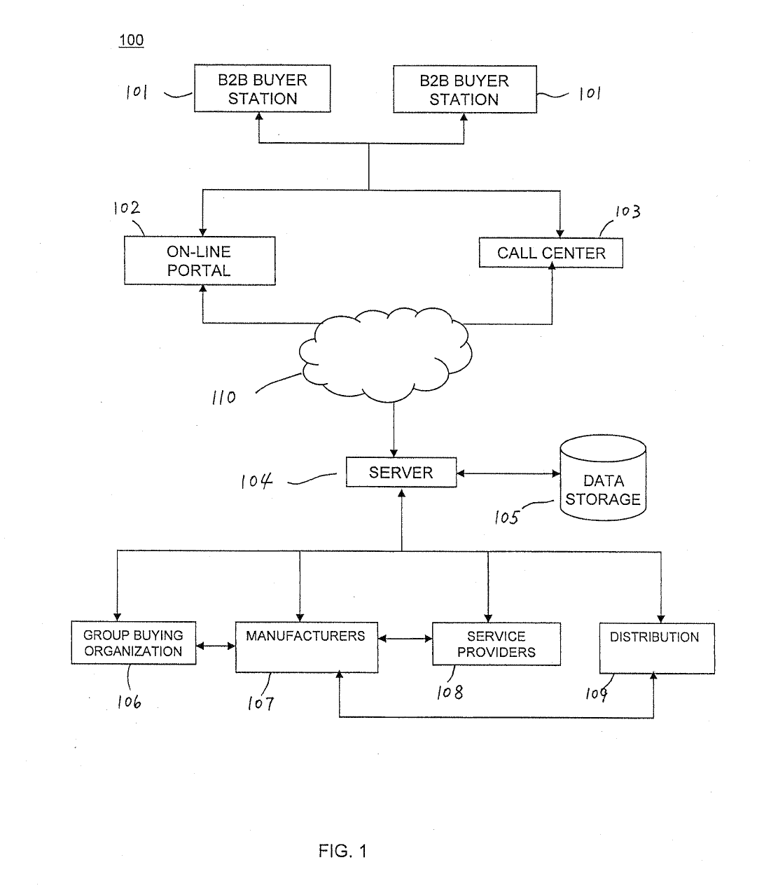

The present invention is directed to a system and method for business-to-business (B2B) provisioning. An exemplary system 100 embodying principles of the present invention is illustrated in FIG. 1. In the system 100, a series of B2B buyer stations 101 (for example, computer terminals 101) communicate with a server 104 via an on-line portal 102 provided over a distributed computer network 110 (for example, the Internet). Alternatively, B2B buyer stations 101 (for example, voice stations 101) may communicate with a conventional call center system 103, which in turn may communicate with the server 104 directly via the distributed network 110 or via the on-line portal 102. The server 104 is able to access a conventional data store 105 in order to store and to retrieve information associated with transactions carried out by the system 100.

The server 104 is further preferably in communication with e-commerce systems of a variety of suppliers of products and services of interest to B2B buyers, for example including one or more of group buying organization (GBO) e-commerce systems 106, product manufacturer e-commerce systems 107, service provider e-commerce systems 108 and/or product distributor e-commerce systems 109. Manufacturers in this case may include traditional product manufacturers, farmers, and/or any other producers of food and non-food products. As suppliers to GBOs, service providers and distributors, manufacturers e-commerce systems will typically communicate with GBO e-commerce systems 106, other product manufacturer e-commerce systems 107, service provider e-commerce systems 108 and product distributor e-commerce systems 109. Communications with and among the supplier e-commerce systems 106-109 may for example occur over the Internet, or by means of one or more of private, local or wide area networks.

The supplier e-commerce systems 106-109 provide information to the server 104 about various products and services available for sale to B2B buyers. As described for example in the '107 patent, the system 100 may preferably be configured to operate as a procurement management system that enables B2B buyers to access this information via the server 104 and data store 105, and to place associated orders with the supplier e-commerce systems 106-109 via the server 104. Prior to placing the associated orders, the server 104 may typically collect payment details from the B2B buyers and obtain appropriate authorization (for example, by secure electronic communication with an associated bank or other credit agency). Alternatively, payment details from a B2B buyer may be collected for authentication directly by the supplier e-commerce system that is furnishing the offered product or service.

In accordance with principles of the present invention, the system 100 is configured to provide a provision point type “deal-of-the-day,” or otherwise time and quantity-fixed deal, by offering a supplier's product or service in bulk quantities to each of a number of B2B buyers (the “collective purchase procedure”). By enabling the supplier to set specific requirements as to the offer period, the total (or minimum) quantity to be sold and the quantity associated with each offer, a manufacturer for example may derive the benefit of being able to optimize production schedules, improve distribution channel efficiency, make use of excess production capacities and/or inventories, and the like. At the same time, buyers may enjoy the benefit of obtaining a specified bulk quantity of the product or service at a clearly-defined price that is further discounted as the result of like purchases made by other buyers in the purchasing group, thereby avoiding the price uncertainty associated with collective purchases made using prior art B2B e-commerce systems. This inventive method is particularly suitable for application to collective purchases by a group of restaurants as buyers. However, it will be apparent to one of skill in the are that the method may also be effectively applied for any number of other types of business groups, and in particular, to small business groups.

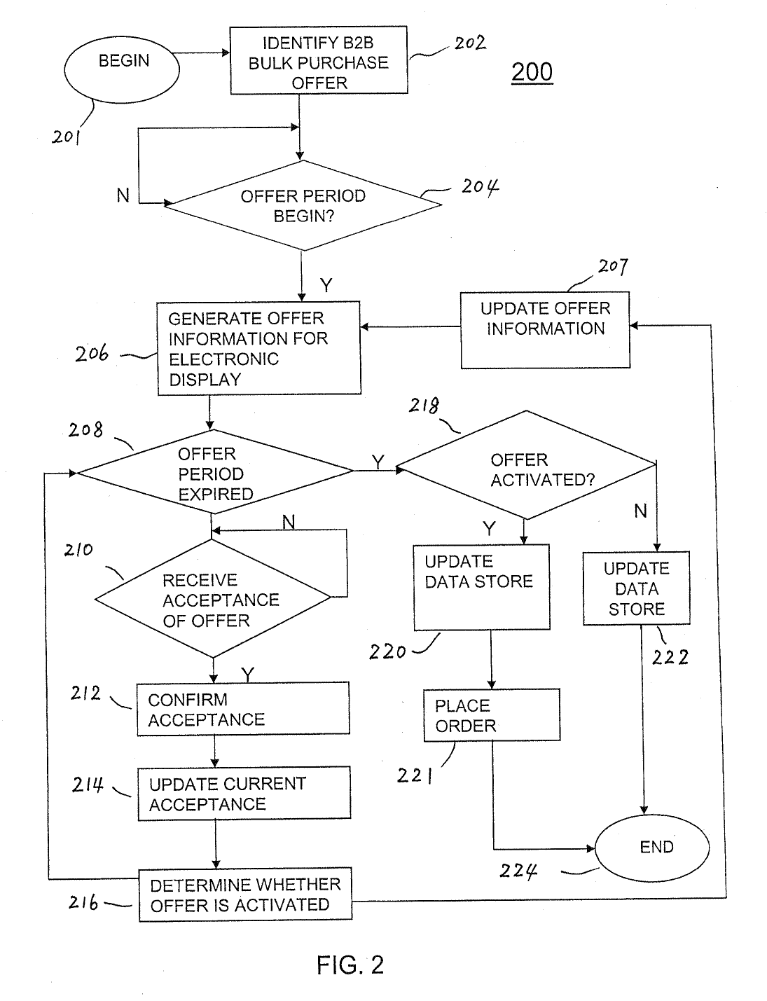

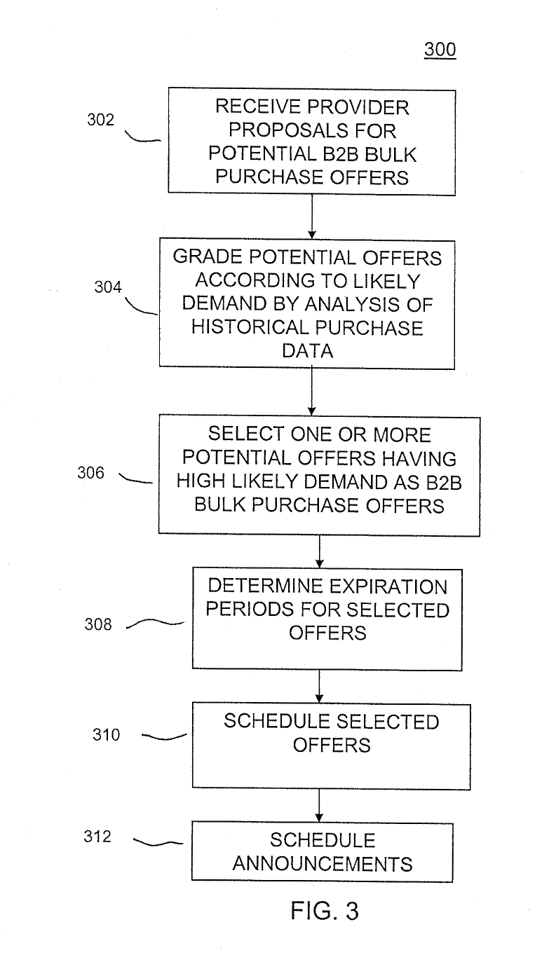

FIG. 2 presents a flow diagram illustrating a process 200 for making collective purchases in accordance with a preferred embodiment of the present invention that is suitable to be performed by the system 100 of FIG. 1. The process 200 begins at step 201 and progresses to step 202, where a suitable bulk purchase offer is determined. This step may be carried out in any number of ways as would be understood by one of skill in the art as being consistent with the principles of the present invention. In particular, an exemplary method 300 for selecting a bulk purchase is illustrated in FIG. 3.

The process 300 of FIG. 3 begins at step 302 with receipt (for example, at the server 104 of FIG. 1) of proposals from several suppliers for potential bulk purchase offers. These offers may be submitted, for example, by the associated suppliers in response to a known overstock condition or excess manufacturing capacity. Alternatively, the server 104 may operated to periodically solicit potential bulk purchase offers from the suppliers. These solicitations may in part be stimulated by feedback submitted at the server 104 by the buyer stations 101 of FIG. 1, and/or on an analysis of data stored in a data store 105 of the server 104 regarding prior offers of a similar nature.

At step 304 of FIG. 3, the server 104 of FIG. 1 is further operated to evaluate and “grade” the potential offers based on historical data. For example, the server 104 may analyze data stored in the data store 105 regarding pricing and demand for past bulk purchase offers of similar products and services, and/or analyze data provided by suppliers as to historical pricing and demand for similar products and services. The analysis may preferably account for time and seasonal effects estimating pricing and demand for the potential offers.

At step 306, the server 104 is operated to select one or more potential bulk purchase offers having high likely demand based on the evaluation performed at step 304. Alternatively and/or in addition, the server 104 may be configured to apply other predetermined rules to further select among several potential bulk purchase offers having high likely demand (for example, selecting offers of interest to featured buyer segments, offers scoring highly when compared to recurrent/seasonal buyer purchasing histories for similar products, and the like).

At step 308, an expiration period is determined for each selected offer. This period may, for example, be specified by the supplier, or alternatively selected, for example, based on an analysis of historical sales performance for similar offers as a function of offer expiration period. At step 310, the offers are scheduled in accordance with the selected expiration periods and selected start dates and times. The start dates and times may be established, for example, by random assignments made by the server 104 to achieve predetermined distribution of assignments, in a predetermined order according to associated product and service types, in a predetermined order associated with supplier identity, offset by a predetermined number of days from a product or service-associated event (e.g., one week prior to Thanksgiving), and any number of other assignment schemes as would be familiar to one of skill in the art of on-line B2B sales).

At step 312, an announcement schedule is established for the scheduled offers. For example, for a “deal-of-the-day,” the deal may be announced coincidentally with its offer start time shortly after the beginning of the offer day. Alternatively, deals may be announced in advance of start dates and start times (for example, weekly or monthly). With offers that are repeatedly offered on a periodic basis to meet ongoing needs of the purchasing business, a significant advance period (for example, a 90-day “pipeline” or “window”) may be announced in order to enable business to schedule repeated purchases according to need and offer availability.

Returning to FIG. 2, the process 200 continues after a bulk purchase offer is identified at step 202 to determine whether or not the offer period has begun (step 204). Server 104 of FIG. 1 may preferably make this determination by comparing a current date and time to offer start date and time information stored in the data store 105. While the period has not yet begun, the process 200 will continue to periodically make this comparison at step 204.

Once the period has begun, the server 104 of FIG. 1 proceeds to retrieve offer information from the data store 105 to generate offer information suitable for display on display screen associated with a buyer station 101 and/or with a station in the call center 103 (step 206 of FIG. 2).

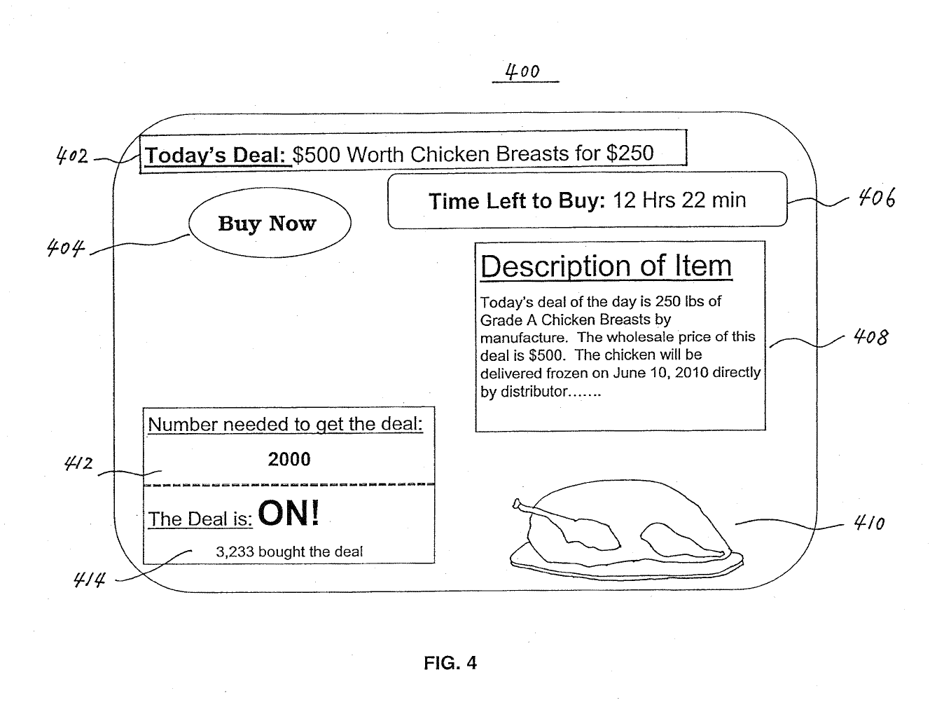

FIG. 4 illustrates an exemplary display screen 400 displaying associated offer information. Most of the information displayed on the display screen 400 is prepared for display by the server 104 based on information about the offer that is stored in the data store 105. For example, in the exemplary display screen 400 of FIG. 4, a headline 402 provides summary information identifying the product offer (“chicken breasts”) and the discount terms (price discounted from $500 to $250). A selector button 404 is provided to enable a buyer to initiate acceptance of the offer. Additional information provided on the exemplary display screen 400 may preferably include a time remaining panel 406 (calculated, for example, by a conventional clock function of the server 104 in view of end date and end time information stored in the data store 105), a detailed description 408 of the offered product item (including, for example, information concerning a delivery schedule), and an illustration 410 of the item. In addition, the exemplary display screen 400 preferably includes a panel 412 indicating a number of buyers required in order for the deal to be activated and individual buyer orders to be processed, and a panel 414 indicating a number of buyers who have presently accepted the offer. When the number of buyers accepted equals or exceeds the number of buyers required, the panel 414 also preferably includes indication that the deal has been activated (“The Deal Is: On!).

Returning to FIG. 2, the process 200 continues after step 206 to determine whether or not the offer period has expired (step 208). As in step 204, this determination may be made by comparing a current date and time to end date and time information for the offer that is stored in the data store 105 of FIG. 1. If the offer period has not expired, the server 104 waits to receive a next acceptance of the offer from one of the buyer stations 101. Upon receipt of an acceptance, the server 104 proceeds to confirm the acceptance (for example, by secure electronic communication with the associated bank or other credit agency, or alternatively with the supplier providing the associated product or service offer), and updates the data store 105 to reflect a change in the number of acceptances (for example, by incrementing a number currently stored in the data store 105 as the current number of acceptances).

At step 216 of FIG. 2, the server 104 of FIG. 1 compares the updated number of acceptances with information in the data store 105 indicating the required number of acceptances to determine whether the offer has been activated. The server 104 then proceeds to update the display screen 400 to indicate the updated number of acceptances, and to update any change in status (for example, such as activation status) at step 207. At step 208, the server 104 once again determines whether the offer period has expired, and determines whether the offer has been activated at step 218.

Optionally, if the supplier has limited the number of offers to be accepted to a maximum number, a process step (not shown) is activated by the server 104 to determine whether the updated number of acceptances is greater than or equal to the maximum. If the offer period has expired and the offer has been activated, or if the updated number of acceptances is greater than or equal to the maximum number of orders allowed by the supplier, the server 104 proceeds at step 220 to update the data store 105 with information indicating the current status of the order, and places a collective order for all buyers represented in the updated number of acceptances with an associated GPO, manufacturer, supplier or distributor, and the process 200 ends at step 221. If the offer has not been activated, the process 200 proceeds directly from steps 208, 218 at step 222 to update the data store 105 with information indicating the current status of the order, and then end at step 221. Optionally (and not shown), the server may prepare an updated display (not shown) for communicating a final status of the order to the buyers.

The server 104 as described with reference to FIG. 1 is suitable for implementation using a general purpose server or computer system as described in more detail below.

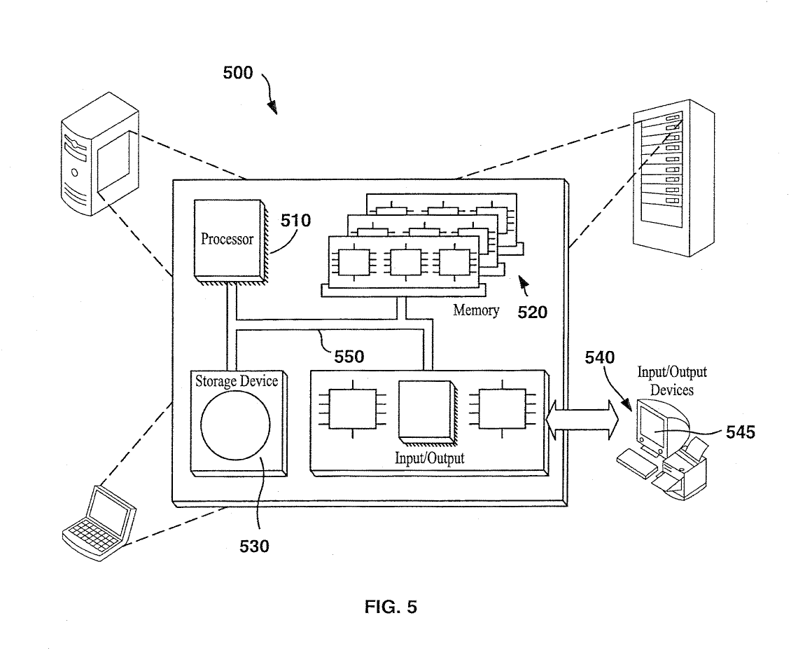

FIG. 5 shows an illustrative computer system 500 suitable for implementing the present invention. The computer system 500 as described herein may comprise, for example, a personal computer running the WINDOWS XP operation system, or a server computer running LINUX or another UNIX-based operating system. The above-described methods of the present invention may be implemented on the computer system 500 as stored program control instructions directed to control application software.

Computer system 500 includes processor 510, memory 520, storage device 530 and input/output devices 540. One of the input/output devices 540 may include a display 545. Some or all of the components 510, 520, 530 and 540 may be interconnected by a system bus 550. Processor 510 may be single or multi-threaded, and may have one or more cores. Processor 510 executes instructions which in the disclosed embodiments of the present invention are the steps described in one or more of FIGS. 2-3. These instructions are stored in memory 520 or in storage device 530. Information may be received and output using one or input/output devices 540.

Memory 520 may store information and may be a computer-readable medium, such as volatile or non-volatile memory. Storage device 530 may provide storage for system 500 including for the example, the previously described database, and may be a computer-readable medium. In various aspects, storage device 530 may be a flash memory device, a floppy disk drive, a hard disk device, and optical disk device, or a tape device.

Input devices 540 may provide input/output operations for system 500. Input/output devices 540 may include a keyboard, pointing device, and microphone. Input/output devices 540 may further include a display unit for displaying graphical user interfaces, a speaker and a printer.

It should of course, be understood that while the present invention has been described with respect to disclosed embodiments, numerous variations are possible without departing from the spirit and scope of the present invention as defined in the claims. Moreover, it is intended that the scope of the present invention include all foreseeable equivalents to the elements and structures as described herein and with reference to the drawing figures. Accordingly, the invention is to be limited only by the scope of the claims and their equivalents.

We claim:

1. A business-to business (B2B) provisioning system in communication with a distributed computer network offering products or services for sale to one or more businesses via one or more stations in communication with the distributed computer network, the system comprising:
a data store storing information for at least one purchase offer to the one or more businesses, the information for the at least one purchase offer identifying an associated product or service for sale, a number of current acceptances made by the one or more businesses, and a number of acceptances required for activating an associate purchase order; and
a processor configured for retrieving the stored information, for delivering at least a portion of the retrieved information to at least one of the one or more stations over the distributed computer network, for receiving an acceptance from at least one of the one or more businesses via the one station, for updating the stored information identifying the number of current acceptances, and for determining whether the updated number of current acceptances is greater than or equal to the number of acceptances required for activating the associated purchase order.

2. The system of claim 1, wherein the processor is further configured to retrieve information from the data store indicating an ending time for the offer, and to deliver the ending time information to the one station over the distributed computer network.

3. The system of claim 1, wherein the processor is further configured to retrieve information from the data store indicating a remaining time for the offer, and to deliver the remaining time information to the one station over the distributed computer network

4. The system of claim 1, wherein the processor is further configured to retrieve information from the data store identifying a provider for the at least one purchase offer.

5. The system of claim 1, wherein the processor is further configured to prepare the information for delivery to the one station in a form that may be processed by the one station to present the information for display on a display screen of the one station.

6. The system of claim 1, wherein the processor is further configured to prepare an order for the updated information identifying the number of current acceptances for delivery to the provider when the updated number of current acceptances is greater than or equal to the number of required acceptances and the ending time of the deal has expired.

7. The system of claim 1, wherein the one or more businesses include one or more restaurants.

8. The system of claim 4, wherein the provider is each selected from the group consisting of group buying organizations, food distributors, food manufacturers, non-food distributors and non-food manufacturers.

9. The system of claim 1, wherein at least one of the one or more stations in communication with the distributed computer network is provided at a call center.

10. The system of claim 1, wherein the purchase offer for the product or service offers the product or service in a bulk quantity.

11. A method for business-to-business (B2B) provisioning offering products or services for sale to one or more businesses via one or more stations in communication with a distributed computer network, the method being implemented on a computer system in communication with the distributed computer network and comprising the computer-implemented steps of:
storing information for at least one purchase offer to the one or more businesses, the information for the at least one purchase offer identifying an associated product or service for sale, a number of current acceptances made by the one or more businesses, and a number of acceptances required for activating an associate purchase order;
retrieving the stored information;
delivering at least a portion of the retrieved information to at least one of the one or more stations;
receiving an acceptance from at least one of the one or more businesses via the one station;
updating the stored information identifying the number of current acceptances; and
determining whether the updated number of current acceptances is greater than or equal to the number of acceptances required for activating the associated purchase order.

12. The method of claim 11, further comprising the computer-implemented steps of:
retrieving information from the data store indicating an ending time for the offer; and
delivering the ending time information to the one or more stations over the distributed computer network.

13. The method of claim 11, further comprising the computer-implemented steps of:
retrieving information from the data store indicating a remaining time for the offer; and
delivering the remaining time information to the one or more stations over the distributed computer network.

14. The method of claim 11, further comprising the computer-implemented step of:
retrieving information from the data store identifying a provider for the at least one purchase offer.

15. The method of claim 11, further comprising the step of:
preparing the information for delivery to the one station in a form that may be processed by the one station to present the information for display on a display screen of the one station.

16. The method of claim 11, further comprising the computer-implemented step of:
preparing an order for the updated number of current acceptances for delivery to the provider when the updated information identifying the updated number of current acceptances is greater than or equal to the number of required acceptances and the ending time of the deal has expired.

17. The method of claim 11, wherein the one or more businesses include one or more restaurants.

18. The method of claim 14, wherein the provider is each selected from the group consisting of group buying organizations, food distributors, food manufacturers, non-food distributors and non-food manufacturers.

19. The method of claim 11, wherein the purchase offer for the product or service offers the product or service in a bulk quantity.

20. The method of claim 10, wherein the data store stores information for a plurality of purchase offers each identifying an associated product or service for sale.

21. The method of claim 20, wherein the at least one purchase offer is selected from among the plurality of purchase offers according to a predetermined selection rule.

22. The method of claim 21, wherein the processor is further configured to retrieve stored information about the plurality of purchase offers and deliver at least a portion of the retrieved information about the plurality of purchase offers according to a predetermined rule.

23. A computer program product, comprising a computer-usable medium having computer-readable instructions embodied therein, the computer-readable program code adapted to be executed to implement a method for business-to-business (B2B) provisioning offering products or services for sale to one or more businesses via one or more stations in communication with a distributed computer network, the method being implemented on a computer system in communication with the distributed computer network and comprising the computer-implemented steps of:
storing information for at least one purchase offer to the one or more businesses, the information for the at least one purchase offer identifying an associated product or service for sale, a number of current acceptances made by the one or more businesses, and a number of acceptances required for activating an associate purchase order;
retrieving the stored information;
delivering at least a portion of the retrieved information to at least one of the one or more stations;
receiving an acceptance from at least one of the one or more businesses via the one station;
updating the stored information identifying the number of current acceptances; and
determining whether the updated number of current acceptances is greater than or equal to the number of acceptances required for activating the associated purchase order.

24. The computer program product of claim 23, further comprising the computer-implemented steps of:
retrieving information from the data store indicating an ending time for the offer; and
delivering the ending time information to the one or more stations over the distributed computer network.

25. The computer program product of claim 23, further comprising the computer-implemented step of:
retrieving information from the data store identifying a provider for the at least one purchase offer.

26. The computer program product of claim 23, further comprising the computer-implemented step of:
preparing an order for the updated number of current acceptances for delivery to the provider when the updated number of current acceptances is greater than or equal to the number of required acceptances and the ending time of the deal has expired.

27. The computer program product of claim 23, wherein the one or more businesses include one or more restaurants.

28. The method of claim 17, wherein the provider is each selected from the group consisting of group buying organizations, food distributors, food manufacturers, non-food distributors and non-food manufacturers.

29. The system of claim 16, wherein the purchase offer for the product or service offers the product or service in a bulk quantity.
